(19) United States
(12) Patent Application Publication
(10) Pub. No.: US 2010/0203837 A1
(43) Pub. Date: Aug. 12, 2010

(54) COMMUNICATION SYSTEM

(75) Inventor: Katsumi TANIGUCHI, Kyoto-shi (JP)

Correspondence Address: Studebaker & Brackett PC, One Fountain Square, 11911 Freedom Drive, Suite 750, Reston, VA, 20190, US

(73) Assignee: MURATA MANUFACTURING CO., LTD., Kyoto-fu (JP)

(21) Appl. No.: 12/766,260

(22) Filed: Apr. 23, 2010

Related U.S. Application Data
(63) Continuation of application No. PCT/JP2008/065837, filed on Sep. 3, 2008.

(30) Foreign Application Priority Data
Oct. 23, 2007 (JP) 2007-275480

(51) Int. Cl. H04B 7/00

(52) U.S. Cl. 455/41.2

(57) ABSTRACT

A communication system that allows a mobile station to locate a slave and that can be used outside a communication range of a base station of a mobile communication network is provided. A slave transmits and receives information to and from a mobile station, such as a cellular phone, by short-range wireless communication. The slave acquires positioning information on its present position and sends it together with identification information from a short-range wireless communication unit. The mobile station includes a receiving portion, a storage portion, a signal determining portion, and a display portion. The receiving portion receives a transmission signal from the slave, and the signal determining portion compares identification information contained in the transmission signal with identification code registered in the storage portion to determine whether they match. When the signal determining portion determines a match, the display portion plots a present position of the slave on map data about surroundings of the mobile station and displays it.

### CROSS REFERENCE TO RELATED APPLICATIONS

The present application is a continuation of International Application No. PCT/JP2008/065837, filed Sep. 3, 2008, which claims priority to Japanese Patent Application No. JP 2007-275480, filed Oct. 23, 2007, the entire contents of each of these applications being incorporated herein by reference in their entirety.

### BACKGROUND

1. Field of the Invention

The invention relates to a communication system that carries out short-range wireless communication between a mobile station and a slave and, when connection is established, indicates it by the mobile station.

2. Description of the Related Art

A communication system that exchanges positional information between mobile stations, such as cellular phones, personal handy-phone system (PHS) phones, or vehicle-installed mobile phones, is proposed. See, for example, Japanese Unexamined Patent Application Publication No. 2005-333247 (hereinafter, the '247 application). In the communication system described in the '247 application, mobile stations and a server for exchanging positional information data are connected to a mobile communication network. Each of the mobile stations acquires positional information by the use of a global positioning system (GPS) and transmits the positional information to the server for exchanging positional information data. The server for exchanging positional information data manages positional information on each mobile station and notifies a specific mobile station of positional information on a different mobile station.

### SUMMARY

Embodiments consistent with the claimed invention can provide, at low costs, a communication system that allows a mobile station to locate a slave and that can be used outside a communication range of a base station of a mobile communication network.

In an embodiment consistent with the claimed invention, a communication system includes a mobile station and a slave. The mobile station transmits and receives information to and from a different mobile station by mobile communication. The slave transmits and receives information to and from the mobile station by short-range wireless communication. The slave includes position acquiring means and sending means. The position acquiring means acquires positional information on the slave. The sending means sends identifying information, for example, unique identifying information, by short-range wireless communication. The mobile station includes receiving means, storage means, comparing means, and position indicating means. The receiving means receives the positional information and the identifying information by the short-range wireless communication. The storage means retains previously registered identifying information. The comparing means compares the identifying information received by the receiving means with the registered identifying information in the storage means to determine whether they match. When the comparing means determines that the received identifying information and the registered identifying information in the storage means match, the position indicating means indicates the positional information received by the receiving means.

Accordingly, a mobile station indicates positional information on its associated slave by short-range wireless communication. Therefore, a user of the mobile station can locate the slave in the vicinity of the mobile station.

In another more specific exemplary embodiment, the mobile station may further include requesting means, and the different mobile station may include request receiving means, request comparing means, and request replying means. The requesting means of the mobile station transmits request information that contains the registered identifying information to the different mobile station by the mobile communication. The request receiving means of the different mobile station receives the request information from the mobile station by the mobile communication. The request comparing means compares the identifying information received by the receiving means with the registered identifying information contained in the request information received by the request receiving means to determine whether they match. When the request comparing means determines that the received identifying information and the registered identifying information contained in the request information match, the request replying means transmits request reply information that contains the positional information received by the receiving means to the mobile station by the mobile communication.

Thus, when no associated slave exists in the vicinity of the mobile station, the different mobile station may search for the presence of that slave.

In another more specific exemplary embodiment, the mobile station may further include request receiving means, request comparing means, request replying means, request reply receiving means, and request reply position indicating means. The request receiving means receives the request information from the different mobile station by the mobile communication. The request comparing means compares the identifying information received by the receiving means with the registered identifying information contained in the request information received by the request receiving means to determine whether they match. When the request comparing means determines that the received identifying information and the registered identifying information contained in the request information match, the request replying means transmits request reply information that contains the positional information received by the receiving means to the different mobile station by the mobile communication. The request reply receiving means receives the request reply information from the different mobile station by the mobile communication. The request reply position indicating means indicates the positional information received by the request reply receiving means.

Thus, when a slave associated with the different mobile station does not exist in the vicinity of the different mobile station, the mobile station may search for the presence of that slave in the vicinity of the mobile station.

In another embodiment consistent with the claimed invention, a communication system includes a mobile station and a slave. The mobile station transmits and receives information to and from a different mobile station by mobile communication. The slave transmits and receives information to and from the mobile station by short-range wireless communication. The slave includes sending means. The sending means sends identifying information, for example, unique identifying information, by the short-range wireless communication. The mobile station includes receiving means, storage means, comparing means, and signal-strength indicating means. The receiving means receives the identifying information by the short-range wireless communication. The storage means retains previously registered identifying information. The comparing means compares the identifying information received by the receiving means with the registered identifying information in the storage means to determine whether they match. When the comparing means determines that the received identifying information and the registered identifying information in the storage means match, the signal-strength indicating means acquires and indicates strength of a reception signal of the identifying information received by the receiving means.

Accordingly, indication at the mobile station is made in response to the strength of the reception signal from its associated slave by short-range wireless communication, so a user of the mobile station can grasp the presence of the slave within a specific range in the vicinity of the mobile station where connection of the short-range wireless communication can be established. In yet another more specific exemplary embodiment, the mobile station may further include requesting means, and the different mobile station may include request receiving means, request comparing means, position acquiring means, and request replying means. The requesting means of the mobile station transmits request information that contains the registered identifying information to the different mobile station by the mobile communication. The request receiving means of the different mobile station receives the request information from the mobile station by the mobile communication. The request comparing means compares identifying information received by receiving means with the registered identifying information contained in the request information received by the request receiving means to determine whether they match. The position acquiring means acquires positional information on the different mobile station. When the request comparing means determines that the received identifying information and the registered identifying information contained in the request information match, the request replying means transmits request reply information that contains the positional information acquired by the position acquiring means to the mobile station by the mobile communication.

Thus, when no associated slave exists in the vicinity of the mobile station, the different mobile station can search for that slave in its vicinity.

In another more specific exemplary embodiment, the mobile station may further include request receiving means, request comparing means, position acquiring means, request replying means, request reply receiving means, and request reply position indicating means. The request receiving means receives the request information from the different mobile station by the mobile communication. The request comparing means compares the identifying information received by the receiving means with the registered identifying information contained in the request information received by the request receiving means to determine whether they match. The position acquiring means acquires positional information on the mobile station. When the request comparing means determines that the received identifying information and the registered identifying information contained in the request information match, the request replying means transmits request reply information that contains the positional information acquired by the position acquiring means to the different mobile station by the mobile communication. The request reply receiving means receives the request reply information from the different mobile station by the mobile communication. The request reply position indicating means indicates the positional information received by the request reply receiving means.

Thus, when a slave associated with the different mobile station does not exist in the vicinity of the different mobile station, the mobile station can search for the presence of that slave.

In another more specific exemplary embodiment, the signal-strength indicating means may issue a warning when the acquired strength of the reception signal is a specific value. Issuing a warning by the mobile station for such a case can enable, for example, a user of the mobile station to be notified of the possibility of missing the position of the slave.

In another more specific exemplary embodiment, the mobile station may have freely changeable reception sensitivity for the short-range wireless communication. If connection between the mobile station and the slave is lost and a warning is issued, changing the reception sensitivity of the mobile station for short-range wireless communication can enable, for example, the connection between the mobile station and the slave to be reestablished.

### BRIEF DESCRIPTION OF DRAWINGS

FIG. 1 is an illustration for describing a search for the position of a slave conducted by a cellular phone according to a first exemplary embodiment.

FIGS. 2A and 2B are illustrations for describing a search for the position of a slave conducted by a plurality of cellular phones according to the first exemplary embodiment.

FIG. 3 is a block diagram of an exemplary slave according to the first exemplary embodiment.

FIG. 4 is a block diagram of an exemplary cellular phone according to the first exemplary embodiment.

FIG. 5 is a control flow diagram of an exemplary control portion of the cellular phone operating in surrounding search display mode.

FIG. 6 is a control flow diagram of an exemplary control portion operating in search request mode.

FIG. 7 is a control flow diagram of an exemplary control portion operating in request reception mode.

FIG. 8 is a control flow diagram of an exemplary control portion operating in remote display mode.

FIG. 9 is a block diagram of a slave according to a second exemplary embodiment.

FIG. 10 is a block diagram of a cellular phone according to the second exemplary embodiment.

### DETAILED DESCRIPTION

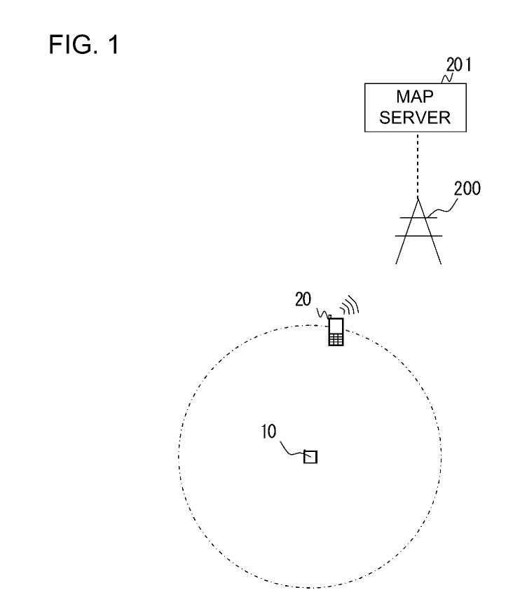

A communication system according to a first exemplary embodiment is described below. FIG. 1 is an illustration for describing a search for the position of a slave conducted by a cellular phone.

A slave 10 can have a shape suitable for being carried, such as the shape of a card, key ring, or badge, and is typically carried by a child. The slave 10 can be driven by a small current and low voltage, and can typically use a button battery as its power source. The slave 10 has its own individually assigned identification code being identifying information and has the GPS positioning function and the short-range wireless transmitting function. The GPS positioning function is the function of measuring the present position of the slave 10. The short-range wireless transmitting function is the function of superimposing positioning information on the above present position and the identification code on a carrier wave for short-range wireless communication (e.g., 400 MHz band) and transmitting that information at intervals of, for example, 10 seconds.

A cellular phone 20 is an example of a mobile station and can be carried by a guardian. The cellular phone 20 can have a mobile communication function and a GPS positioning function. The mobile communication function can be the function of transmitting and receiving an audio signal and a data signal to and from a different cellular phone through a mobile communication network 200. The GPS positioning function can be an example of the function of measuring its present position. The cellular phone 20 can acquire map data about its surroundings from a map server 201 provided in the mobile communication network 200 on the basis of the present position of the cellular phone 20 measured by the GPS positioning function and display it on, for example, a liquid crystal display portion.

The cellular phone 20 retains previously registered identification code of its associated slave 10 and also has the short-range wireless receiving function. The short-range wireless receiving function is the function of receiving a transmission signal for short-range wireless communication from the slave 10. When a transmission signal received by the cellular phone 20 by short-range wireless communication contains the identification code of the slave 10, the cellular phone 20 can ascertain the presence of the slave 10 within the short-range wireless communication range. The cellular phone 20 can include a freely extensible antenna for the short-range wireless communication and thus its reception sensitivity can be freely changed. For example, it may be preferable that the distance at which a transmission signal can be received by the short-range wireless communication be changed in the range of approximately 30 m to approximately 100 m.

The cellular phone 20 plots the position of the slave 10 based on the positional information on the slave 10 contained in the transmission signal on map data about its surroundings and displays it on, for example, the liquid crystal display portion. The cellular phone 20 can measure the strength of a reception signal of the transmission signal and also display the measured strength of the reception signal on, for example, the liquid crystal display portion. When the strength of the reception signal decreases to a specific value or less, the cellular phone 20 can display a warning on the liquid crystal display portion and emits a warning sound. It can also notify departure of the slave by other means, for example, a vibrator.

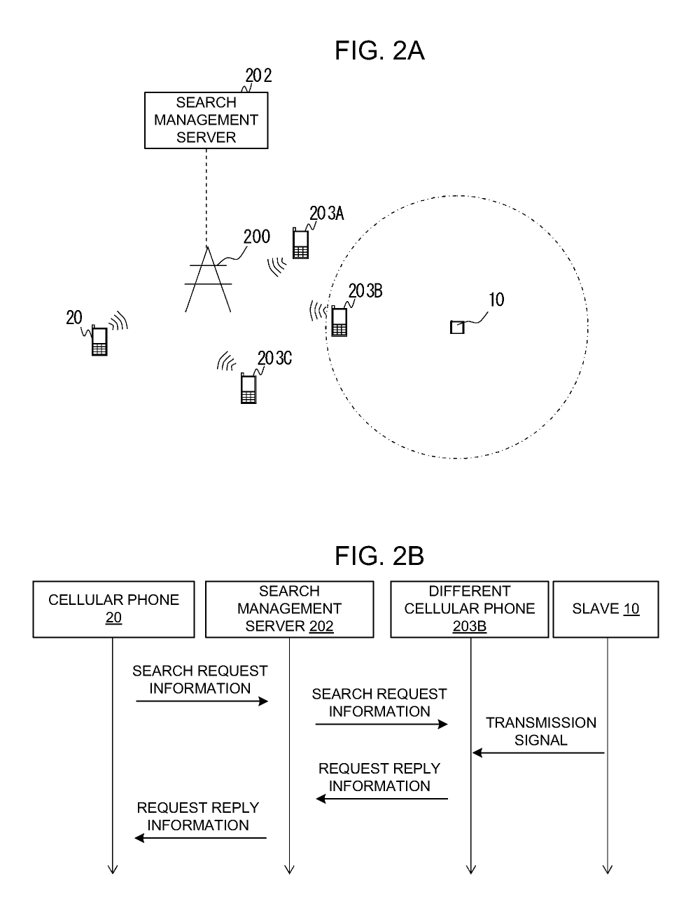

FIGS. 2A and 2B are illustrations for describing a search for the position of the slave 10 conducted by a plurality of cellular phones. FIG. 2(A) is a concept diagram of the communication system, and FIG. 2(B) is an illustration for describing transmission and reception of information between components of the communication system.

Different cellular phones 203A to 203C have substantially the same configuration as that of the cellular phone 20 and retain previously registered identification codes of respective associated slaves. Here, a method of searching for a slave by the cellular phone 20 is described based on an example in which the slave 10 is in a region where the slave 10 can communicate only with the different cellular phone 203B by short-range wireless communication.

When the slave 10 and the cellular phone 20 are not in the short-range wireless communication range, the cellular phone 20 transmits search request information to a search management server 202 over the mobile communication network 200. The search request information contains the identification code of the slave 10. The search management server 202 is connected to the mobile communication network 200 and relays request information from a registered cellular phone to another registered cellular phone. The different cellular phones 203A to 203C receive the search request information relayed by the search management server 202 over the mobile communication network 200. The different cellular phones 203A to 203C search for the slave having the identification code contained in the search request information.

The slave 10 acquires positioning information on its present position from a GPS signal, for example, and can superimpose the positioning information and the identification code on a carrier wave for short-range wireless communication (e.g., 400 MHz band) and transmit it.

As shown in FIG. 2A, the slave 10 and the different cellular phone 203B are in the short-range wireless communication range, so the different cellular phone 203B receives a transmission signal from the slave 10. The identification code contained in the transmission signal is the same as the identification code contained in the search request information, so the different cellular phone 203B generates request reply information that contains the positioning information and identification code contained in the transmission signal, and transmits the request reply information to the search management server 202 over the mobile communication network 200. The search management server 202 identifies the associated cellular phone 20 on the basis of the identification code contained in the request reply information and transmits the request reply information containing the positioning information on the present position of the slave 10 to the cellular phone 20.

The cellular phone 20 can acquire map data about surroundings of the slave 10 on the basis of the positioning information on the present position of the slave 10 from the map server 201 provided in the mobile communication network 200 and displays it on, for example, the liquid crystal display portion. Additionally, the cellular phone 20 plots the position of the slave 10 based on the positioning information on the slave 10 on the map data about surroundings of the slave 10 and displays it on, for example, the liquid crystal display portion.

Accordingly, the cellular phone 20 carried by, for example, a guardian can capture positional information on the slave 10 carried by, for example, a child. If the cellular phone 20 and the slave 10 are in a region where both can communicate with each other by short-range wireless communication, the present position of the slave 10 can be transmitted and received by short-range wireless communication and that position can be ascertained by the cellular phone 20. Even if the cellular phone 20 and the slave 10 are not in the range where both can communicate with each other by short-range wireless communication, the present position of the slave 10 can be ascertained by the use of a different cellular phone over the mobile communication. The slave 10 can have a simple configuration and thus the cost of the terminal can be reduced. In addition, it is not necessary for the slave 10 to join the mobile communication network. Even if the cellular phone 20 is outside a communication range of a base station of the mobile communication network, the cellular phone 20 can locate the slave 10 being adjacent thereto by short-range wireless communication.

While an example of using the search management server 202 has been described above, in other examples the cellular phone 20 can transmit search request information directly to a different cellular phone over the mobile communication network 200 without providing it through the search management server 202.

Alternatively, in other examples, a user of the cellular phone 20 can register a different cellular phone as a destination of search request information in the search management server 202, and the search management server 202 can transmit the search request information only to that registered different cellular phone.

Also, in some embodiments a provider of the mobile communication network may look for an owner of a cellular phone to which the search service is to be supplied, charge the owner, and register the cellular phone as a target for the service in the search management server 202.

Additionally, transmitting mail that requests extension of the antenna to a cellular phone registered in the search management server 202 from a provider of the mobile communication network may also be preferable.

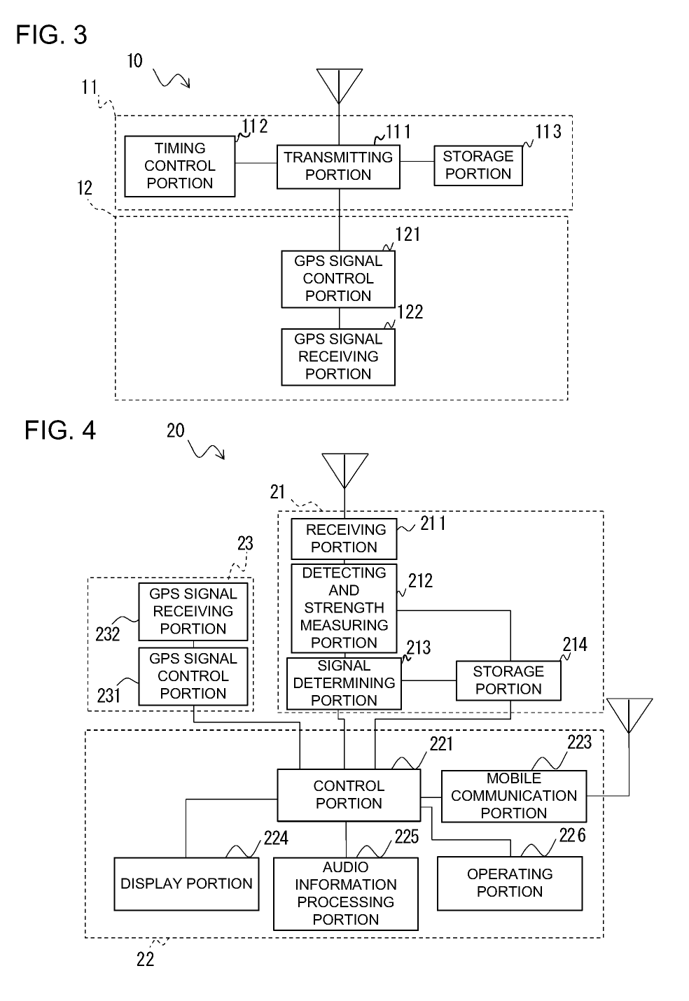

FIG. 3 is a block diagram of an exemplary slave 10. As shown in FIG. 3, the slave 10 includes a short-range wireless communication unit 11 and a GPS unit 12. The GPS unit 12 corresponds to position acquiring means, includes a GPS signal receiving portion 122 and a GPS signal control portion 121, and measures the present position by a publicly known GPS measuring technique. The GPS signal receiving portion 122 receives GPS signals emitted from four or more satellites. The GPS signal control portion 121 calculates the position of the slave 10 (receiver) using these GPS signals. Specifically, a satellite superimposes almanac data being satellite orbital information and ephemeris data showing detailed satellite orbital information and time of sending a signal on the GPS signal and sends it by radio waves. The GPS signal control portion 121 calculates the distance between the slave 10 and each of the four satellites from which the GPS signals have been received, acquires the GPS coordinates of the slave 10 by the triangle intersection method, and converts them into positioning information.

The short-range wireless communication unit 11 includes a transmitting portion 111, a timing control portion 112, and a storage portion 113 and transmits information by short-range wireless communication. The timing control portion 112 controls timing of activating the transmitting portion. Specifically, the timing control portion 112 causes the transmitting portion to intermittently transmit a transmission signal by short-range wireless communication at intervals of several tens of seconds to several minutes. The storage portion 113 retains its identification code. The transmitting portion 111 corresponds to sending means and superimposes identification code read from the storage portion 113 and positioning information read from the GPS signal control portion 121 on a carrier wave for short-range wireless communication and sends it from the antenna at timing provided by the timing control portion 112. Here, the timing control portion 112 may also provide timing of operating the GPS unit 12 such that the slave 10 is made to intermittently operate as a whole. This may be preferable because power consumption of the slave 10 can be reduced.

In some embodiments, it may be preferable that, in the slave 10, a voltage applied to the transmitting portion 111 can be varied and an output signal level of a transmission signal can be changed. For example, if the slave 10 automatically adjusts an output signal level of a transmission signal and sends a transmission signal having a large output signal level once every several times, in the event that the position of the slave 10 is missed, the possibility of finding the slave 10 is increased because the cellular phone 20 can receive the transmission signal having the large output level.

FIG. 4 is a block diagram of an exemplary cellular phone 20. The cellular phone 20 includes a short-range wireless communication unit 21, a cellular phone unit 22, and a GPS unit 23.

As shown in FIG. 4, the short-range wireless communication unit 21 can include a receiving portion 211, a detecting and strength measuring portion 212, a signal determining portion 213, and a storage portion 214 and receives a transmission signal transmitted from the slave 10 by short-range wireless communication. The receiving portion 211 corresponds to receiving means and receives the transmission signal by short-range wireless communication. The detecting and strength measuring portion 212 measures the strength of a reception signal of the transmission signal and outputs it to the storage portion 214, and detects the transmission signal and outputs identification code and positioning information contained in the transmission signal to the signal determining portion 213. The storage portion 214 corresponds to storage means and retains previously registered identification code of the slave 10 associated with the cellular phone 20. The storage portion 214 also temporarily stores the above strength of the reception signal. The signal determining portion 213 corresponds to comparing means and reads the previously registered identification code from the storage portion 214 and determines whether the identification code detected by the detecting and strength measuring portion 212 is the same as that registered identification code. If the identification code is the same as the registered identification code, the signal determining portion 213 reads the strength of the reception signal from the storage portion 214 and outputs the positioning information on the slave 10 and the strength of the reception signal to the cellular phone unit 22.

The GPS unit 23 includes a GPS signal receiving portion 232 and a GPS signal control portion 231 and measures the position of the cellular phone 20, for example, by a publicly known GPS measuring technique. The GPS signal receiving portion 232 receives GPS signals emitted from four or more satellites. The GPS signal control portion 231 acquires the GPS coordinates of the cellular phone 20 using these GPS signals, converts them into positioning information, and outputs it to the cellular phone unit 22.

The cellular phone unit 22 includes a control portion 221, a mobile communication portion 223, a display portion 224, an audio information processing portion 225, and an operating portion 226. The operating portion 226 accepts an operation of a user. In response to the operation on the operating portion 226, the control portion 221 exercises operational control over the cellular phone 20. The mobile communication portion 223 transmits and receives an audio signal and transmits and receives a data signal through the mobile communication network. The audio information processing portion 225 performs audio signal processing.

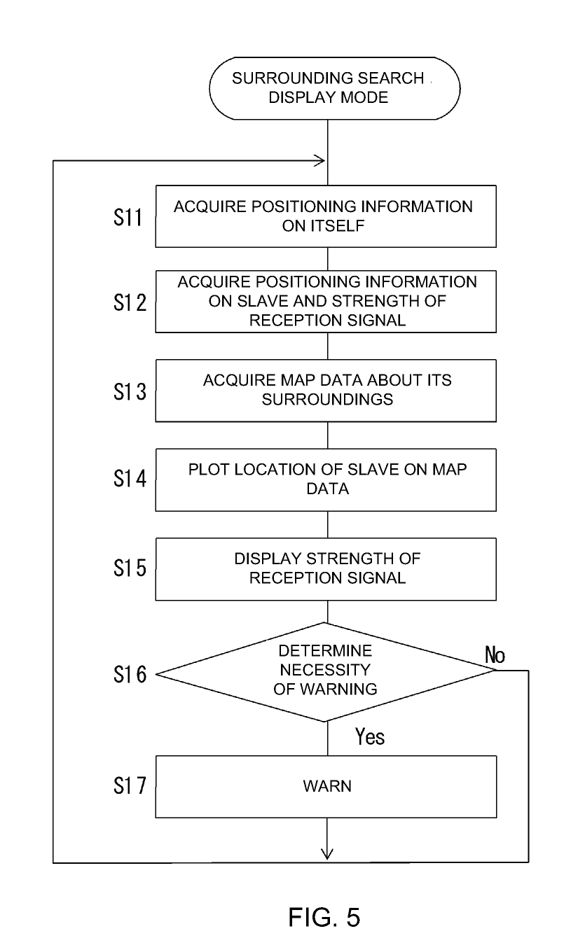

FIGS. 5 to 8 are exemplary control flow diagrams of the control portion 221.

When a specific operation is conducted on the operating portion 226, the control portion 221 can exercise the operational control illustrated in FIG. 5 in surrounding search display mode.

The control portion 221 operating in surrounding search display mode causes the GPS unit 23 to operate so as to acquire positioning information on the cellular phone 20 in step S11. In step S12, the control portion 221 causes the short-range wireless communication unit 21 to operate so as to acquire positioning information on the present position of the slave 10 and the strength of the reception signal. In step S13, the control portion 221 acquires map data about surroundings of the cellular phone 20 through the mobile communication portion 223 over the mobile communication network. At this time, the cellular phone unit 22 transmits the positioning information on the cellular phone 20 acquired by the GPS unit 23 to the map server over the mobile communication network and receives the map data transmitted from the map server. In step S14, the control portion 221 plots the present position of each of the cellular phone 20 and the slave 10 on the map data about surroundings of the cellular phone 20 on the basis of the positioning information on the slave 10 acquired by the short-range wireless communication unit 21 and causes the display portion 224 to display it. In step S15, the control portion 221 causes the display portion 224 to display the strength of the reception signal on the basis of the strength of the reception signal acquired by the short-range wireless communication unit 21. In step S16, the control portion 221 determines whether the strength of the reception signal changes such that it becomes lower than a specific threshold. If it changes so, in step S17, a warning is sounded and/or displayed on the liquid crystal display portion. The display portion 224 corresponds to reception-signal strength indicating means.

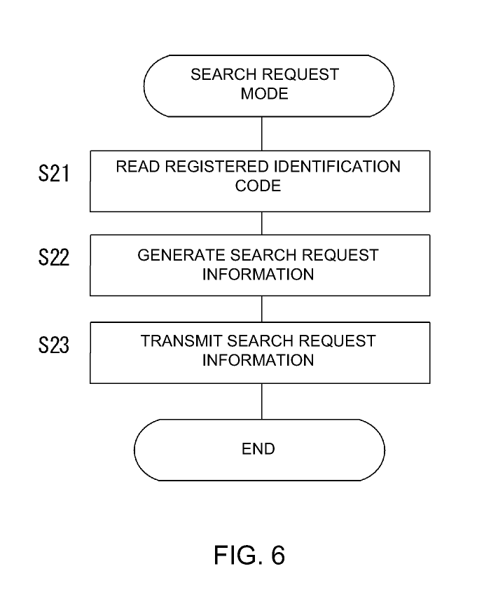

When no slave 10 is in the vicinity of the cellular phone 20 and a specific operation is conducted on the operating portion 226, the control portion 221 can exercise the operational control illustrated in FIG. 6 in search request mode.

The control portion 221 operating in search request mode reads the identification code of the slave 10 from the storage portion 214 in step S21. In step S22, the control portion 221 generates search request information that contains the registered identification code. In step S23, the control portion 221 transmits the search request information to the slave search management server through the mobile communication portion 223 over the mobile communication network. The mobile communication portion 223 corresponds to requesting means.

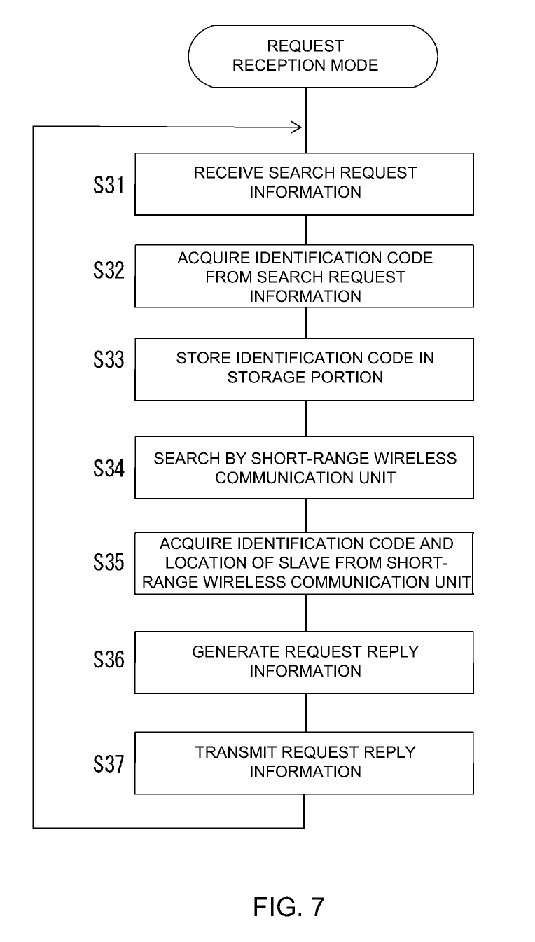

When the mobile communication portion 223 receives search request information, the control portion 221 can excise the operational control illustrated in FIG. 7 in request reception mode. The mobile communication portion 223 corresponds to request receiving means.

When receiving search request information in step S31, the control portion 221 operating in request reception mode starts operational control in request reception mode. In step S32, the control portion 221 acquires identification code of a different slave contained in the search request information. In step S33, the control portion 221 temporarily stores the identification code of the different slave. In step S34, the control portion 221 searches for the slave having that identification code by the use of the short-range wireless communication unit 21. If receiving a transmission signal containing that identification code, the short-range wireless communication unit 21 outputs positioning information on the different slave contained in the transmission signal to the cellular phone unit 22. The signal determining portion 213 of the short-range wireless communication unit 21 corresponds to request comparing means. In step S35, the control portion 221 acquires the positioning information on the different slave and the identification code of the different slave from the short-range wireless communication unit 21. In step S36, the control portion 221 generates request reply information containing the positioning information on the different slave and the identification code of the different slave. In step S37, the control portion 221 causes the mobile communication portion 223 to transmit the request reply information therefrom to the slave search management server. The mobile communication portion 223 corresponds to request replying means.

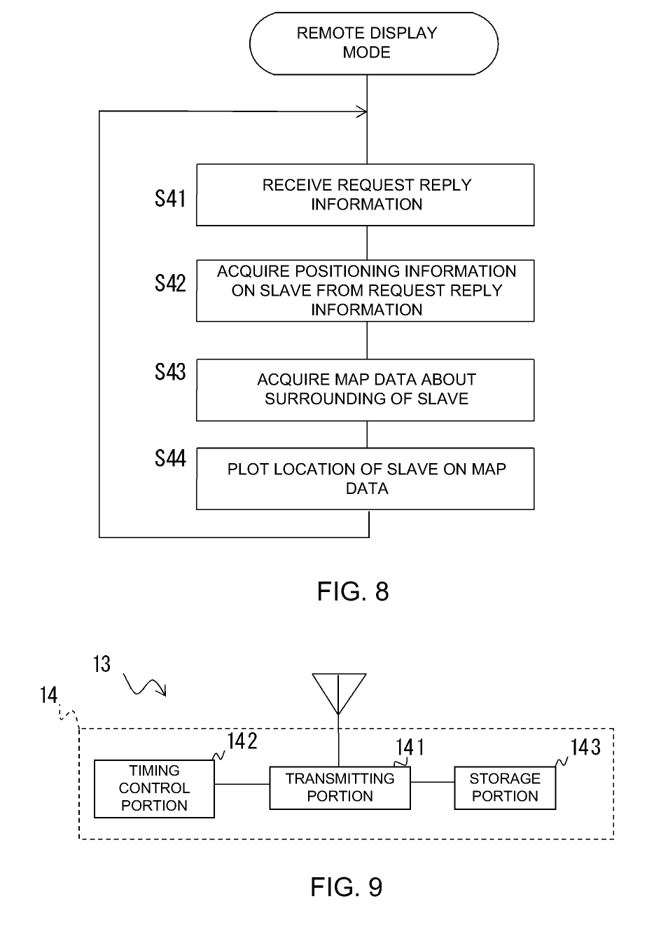

When the mobile communication portion 223 receives request reply information, the control portion 221 can exercise operational control illustrated in FIG. 8 in remote display mode. The mobile communication portion 223 corresponds to request reply receiving means.

When receiving request reply information in step S41, the control portion 221 operating in remote display mode starts operational control in remote display mode. In step S42, the control portion 221 acquires positioning information on the slave 10 contained in the request reply information. In step S43, the control portion 221 acquires positional data about surroundings of the slave 10 through the mobile communication portion 223 over the mobile communication network on the basis of the positioning information on the slave 10. At this time, the cellular phone unit 22 transmits the positioning information on the slave 10 contained in the request reply information to the map server over the mobile communication network and receives map data transmitted from the map server. In step S44, the control portion 221 plots the present position of the slave 10 on the map data about surroundings of the slave 10 and causes the display portion 224 to display it. The display portion 224 corresponds to request reply position indicating means.

Next, a communication system according to a second exemplary embodiment is described. This exemplary embodiment is different from the above embodiment in that a slave 13 includes no GPS unit, an antenna for short-range wireless communication of a cellular phone 24 is inextensible, and its reception sensitivity is fixed.

FIG. 9 is a block diagram of an exemplary slave 13. The slave 13 includes a short-range wireless communication unit 14. The short-range wireless communication unit 14 includes a transmitting portion 141, a timing control portion 142, and a storage portion 143 and transmits information by short-range wireless communication. The timing control portion 142 controls timing of activating the transmitting portion. Specifically, the timing control portion 142 causes the transmitting portion to intermittently transmit a transmission signal by short-range wireless communication at intervals of several tens of seconds to several minutes. The storage portion 143 retains its identification code. The transmitting portion 141 superimposes the identification code read from the storage portion 143 on a carrier wave for short-range wireless communication and sends it from the antenna at timing provided by the timing control portion 112. Accordingly, from the slave 13, a transmission signal that contains information on the identification code for short-range wireless communication is sent.

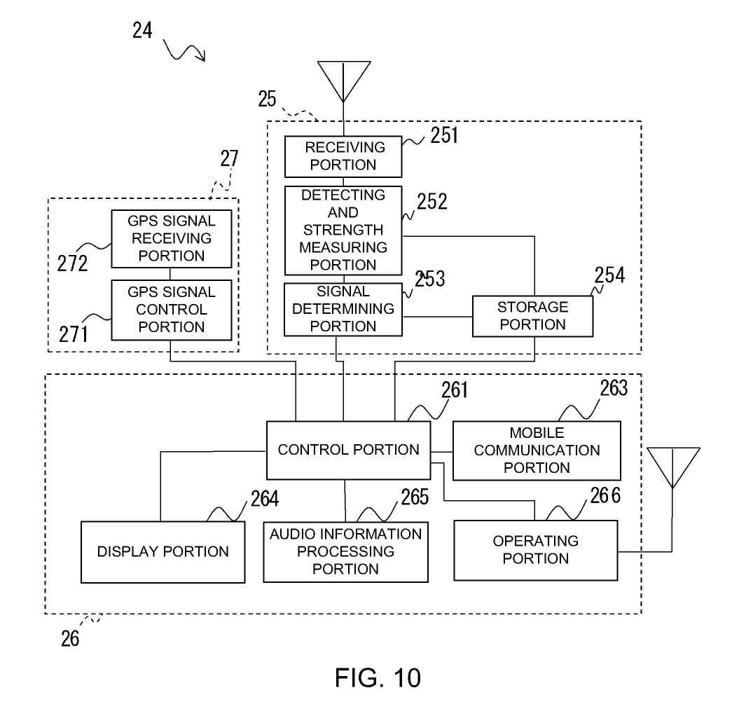

FIG. 10 is a block diagram of an exemplary cellular phone 24. The cellular phone 24 includes a short-range wireless communication unit 25, a cellular phone unit 26, and a GPS unit 27.

The short-range wireless communication unit 25 includes a receiving portion 251, a detecting and strength measuring portion 252, a signal determining portion 253, and a storage portion 254 and receives a transmission signal transmitted from the slave 13 by short-range wireless communication. The receiving portion 251 receives the transmission signal by short-range wireless communication. The detecting and strength measuring portion 252 measures the strength of a reception signal of the transmission signal and outputs it to the storage portion 254, and detects the transmission signal and outputs identification code contained in the transmission signal to the signal determining portion 253. The storage portion 254 retains previously registered identification code of the slave 13 associated with the cellular phone 24. The storage portion 254 also temporarily stores the above strength of the reception signal. The signal determining portion 253 reads the previously registered identification code from the storage portion 254 and determines whether the identification code detected by the detecting and strength measuring portion 252 is the same as the registered identification code. If the identification code is the same as the registered identification code, the signal determining portion 253 reads the strength of the reception signal from the storage portion 254 and outputs, to the cellular phone unit 26, the strength of the reception signal of the transmission signal transmitted from the slave 13.

The GPS unit 27 includes a GPS signal receiving portion 272 and a GPS signal control portion 271 and measures the position of the cellular phone 24 by a publicly known GPS measuring technique. The GPS signal receiving portion 272 receives GPS signals emitted from at least four satellites. The GPS signal control portion 271 acquires the GPS coordinates of the cellular phone 24 using these GPS signals, converts them into positioning information, and outputs it to the cellular phone unit 26.

The cellular phone unit 26 includes a control portion 261, a mobile communication portion 263, a display portion 264, an audio information processing portion 265, and an operating portion 266. The operating portion 266 accepts an operation of a user. In response to the operation on the operating portion 266, the control portion 261 exercises operational control over the cellular phone 24. The mobile communication portion 263 transmits and receives an audio signal and transmits and receives a data signal through the mobile communication network. The audio information processing portion 265 performs audio signal processing.

When a specific operation is conducted on the operating portion 266, the control portion 261 exercises operational control in surrounding search display mode. The control portion 261 causes the GPS unit 27 to operate so as to acquire positioning information on the cellular phone 24 and causes the short-range wireless communication unit 25 to operate so as to acquire the strength of a reception signal of a transmission signal from the slave 10. The control portion 261 plots the present position of the cellular phone 24 on map data about surroundings of the cellular phone 24 on the basis of the positioning information on the cellular phone 24 acquired by the GPS unit 23 and causes the display portion 264 to display it. At this time, the cellular phone unit 26 transmits the positioning information on the cellular phone 24 acquired by the GPS unit 27 to the map server over the mobile communication network and receives the map data transmitted from the map server. The control portion 261 estimates the distance from the cellular phone 24 to the slave 13 on the basis of the strength of the reception signal and displays a circle whose diameter varies with that distance in adjacent areas of the cellular phone 24. If that strength of the reception signal changes such that it becomes lower than a specific threshold, the control portion 261 sounds a warning and/or displays it on the liquid crystal display portion.

When no slave 13 is in the vicinity of the cellular phone 24 and a specific operation is conducted on the operating portion 266, the control portion 261 exercises operational control in search request mode. In this case, the control portion 261 reads the identification code of the slave 13 from the storage portion 254, generates search request information containing that identification code, and transmits it to the slave search management server through the mobile communication portion 263 over the mobile communication network.

When the mobile communication portion 263 receives search request information, the control portion 261 exercises operational control in request reception mode. In this case, the control portion 261 causes the storage portion 254 to temporarily store identification code of a different slave contained in the search request information and searches for the slave having that identification code by the use of the short-range wireless communication unit 25. If receiving a transmission signal containing that identification code, the short-range wireless communication unit 25 outputs the strength of the reception signal of that transmission signal to the cellular phone unit 26. The control portion 261 of the cellular phone unit 26 generates request reply information containing the positioning information on the cellular phone 24 acquired by the GPS unit 27, the strength of the reception signal of the transmission signal from the different slave, and that identification code. The request reply information is transmitted from the mobile communication portion 263 to the slave search management server.

When the mobile communication portion 263 receives request reply information, the control portion 261 exercises operational control in remote display mode. In this case, the control portion 261 plots the present position of the different cellular phone on map data about surroundings of the different cellular phone on the basis of positioning information on the different cellular phone contained in the request reply information and causes the display portion 264 to display it. The map data about surroundings of the different cellular phone is acquired through the mobile communication portion 263 over the mobile communication network. At this time, the cellular phone unit 26 transmits the positioning information on the different cellular phone contained in the request reply information to the map server over the mobile communication network and receives the map data transmitted from the map server. The display portion 264 displays the map data about surroundings of the different cellular phone and the present position of the different cellular phone on, for example, the liquid crystal display portion.

The control portion 261 estimates the distance from the different cellular phone to the slave 13 on the basis of the strength of the reception signal contained in the request reply information and displays a circle whose diameter varies with that distance in adjacent areas of the different cellular phone.

Accordingly, even when the slave 13 has no GPS positioning function, or even when the slave 13 and the cellular phone 24 are not in a region where both can communicate with each other by short-range wireless communication, a guardian or any other person who uses the cellular phone 24 can roughly locate the slave 13.

Embodiments consistent with the claimed invention can facilitate reducing or eliminating the cost of acquiring plural cellular phones, the cost of joining the mobile communication network and continuing the subscription, and the cost of communication, which can amount to a significant expense to a user. For example, in order to capture positional information on a child by a guardian (e.g., a parent and child) using current systems, it is necessary for not only the guardian but also the child, who may not need mobile communication, to have respective mobile stations (e.g., cellular phones). In embodiments consistent with the claimed invention, the slave can merely include the sending means (sending function) for the short-range wireless communication, so it can be configured at low costs, there is no need to join a mobile communication network, and the use of short-range wireless communication can reduce the cost of communication.

Embodiments consistent with the claimed invention can facilitate use of a communication system that allows a mobile station to locate a slave outside a communication range of a base station in a mobile communication network.

For example, when users of this communication system are a parent and child, in a more specific implementation, a guardian aims to capture positional information on the child, if the child has a slave and the guardian has a mobile station, the guardian can grasp the presence of the child within a region where short-range wireless communication of the mobile station can be made. Such grasping of the position of the slave by the mobile station can be achieved with a reduced cost of the terminal of the slave, and the cost of joining a mobile communication network by the slave and the cost of communication can be reduced. Even if the slave is outside a communication range of a base station of the mobile communication network, the short-range wireless communication enables the grasping of the position of the slave.

In the above configuration examples, a cellular phone is used as a target device of a mobile station in the description. However, aside from this, a device that is a mobile station of, for example, a PHS or a vehicle-installed mobile phone can also be used as the target device. Additionally, although the case where radio waves are used in short-range wireless communication is described above, ultrasonic waves or light may also be used.

Although a limited number of embodiments are described herein, one of ordinary skill in the art will readily recognize that there could be variations to any of these embodiments and those variations would be within the scope of the appended claims. Thus, it will be apparent to those skilled in the art that various changes and modifications can be made to the communication system described herein without departing from the scope of the appended claims and their equivalents.

1. A communication system comprising:
a mobile station for transmitting and receiving information to and from a different mobile station by mobile communication; and
a slave for transmitting and receiving information to and from the mobile station by short-range wireless communication,
wherein the slave includes:
position acquiring means for acquiring positional information on the slave; and
sending means for sending identifying information and the positional information by short-range wireless communication,
wherein the mobile station includes:
receiving means for receiving the identifying information and the positional information by the short-range wireless communication;
storage means retaining previously registered identifying information;
comparing means for comparing the identifying information received by the receiving means with the registered identifying information in the storage means to determine whether they match; and
position indicating means for, when the comparing means determines that the received identifying information and the retained registered identifying information match, indicating the positional information received by the receiving means.

2. The communication system according to claim 1, wherein the mobile station further includes requesting means for transmitting request information that contains the registered identifying information to the different mobile station by the mobile communication,
the different mobile station including:
request receiving means for receiving the request information from the mobile station by the mobile communication;
request comparing means for comparing the identifying information received by the receiving means with the registered identifying information contained in the request information received by the request receiving means to determine whether they match; and
request replying means for, when the request comparing means determines that the received identifying information and the registered identifying information contained in the received request information match, transmitting request reply information that contains the positional information received by the receiving means to the mobile station by the mobile communication.

3. The communication system according to claim 2, wherein the mobile station further includes:
request receiving means for receiving the request information from the different mobile station by the mobile communication;
request comparing means for comparing the identifying information received by the receiving means with the registered identifying information contained in the request information received by the request receiving means to determine whether they match;
request replying means for, when the request comparing means determines that the received identifying information and the registered identifying information contained in the request information match, transmitting request reply information that contains the positional information received by the receiving means to the different mobile station by the mobile communication;
request reply receiving means for receiving the request reply information from the different mobile station by the mobile communication; and
request reply position indicating means for indicating the positional information received by the request reply receiving means.

4. The communication system according to claim 1, wherein the mobile station further includes signal-strength indicating means for, when the comparing means determines that the received identifying information and the retained registered identifying information match, acquiring and indicating strength of a reception signal of the identifying information received by the receiving means.

5. The communication system according to claim 2, wherein the mobile station further includes signal-strength indicating means for, when the comparing means determines that the received identifying information and the retained registered identifying information match, acquiring and indicating strength of a reception signal of the identifying information received by the receiving means.

6. The communication system according to claim 3, wherein the mobile station further includes signal-strength indicating means for, when the comparing means determines that the received identifying information and the retained registered identifying information match, acquiring and indicating strength of a reception signal of the identifying information received by the receiving means.

7. The communication system according to claim 4, wherein, when the acquired strength of the reception signal is a specific value, the signal-strength indicating means issues a warning.

8. The communication system according to claim 5, wherein, when the acquired strength of the reception signal is a specific value, the signal-strength indicating means issues a warning.

9. The communication system according to claim 6, wherein, when the acquired strength of the reception signal is a specific value, the signal-strength indicating means issues a warning.

10. The communication system according to claim 7, wherein the mobile station has freely changeable reception sensitivity for the short-range wireless communication.

11. The communication system according to claim 8, wherein the mobile station has freely changeable reception sensitivity for the short-range wireless communication.

12. The communication system according to claim 9, wherein the mobile station has freely changeable reception sensitivity for the short-range wireless communication.

13. A communication system comprising:
a mobile station for transmitting and receiving information to and from a different mobile station by mobile communication; and
a slave for transmitting and receiving information to and from the mobile station by short-range wireless communication,
wherein the slave includes:
sending means for sending identifying information by the short-range wireless communication,
wherein the mobile station includes:
receiving means for receiving the identifying information by the short-range wireless communication;
storage means retaining previously registered identifying information;
comparing means for comparing the identifying information received by the receiving means with the registered identifying information in the storage means to determine whether they match; and
signal-strength indicating means for, when the comparing means determines that the received identifying information and the registered identifying information retained in the storage means match, acquiring and indicating strength of a reception signal of the identifying information received by the receiving means.

14. The communication system according to claim 13, wherein the mobile station further includes requesting means for transmitting request information that contains the registered identifying information to the different mobile station by the mobile communication,
the different mobile station including:
request receiving means for receiving the request information from the mobile station by the mobile communication;
request comparing means for comparing identifying information received by receiving means with the registered identifying information contained in the request information received by the request receiving means to determine whether the received identifying information and the registered identifying information match;
position acquiring means for acquiring positional information on the different mobile station; and
request replying means for, when the request comparing means determines that the received identifying information and the registered identifying information contained in the request information match, transmitting request reply information that contains the positional information acquired by the position acquiring means to the mobile station by the mobile communication.

15. The communication system according to claim 14, wherein the mobile station further includes:
request receiving means for receiving the request information from the different mobile station by the mobile communication;
request comparing means for comparing the identifying information received by the receiving means with the registered identifying information contained in the request information received by the request receiving means to determine whether they match;
position acquiring means for acquiring positional information on the mobile station;
request replying means for, when the request comparing means determines that the received identifying information and the registered identifying information contained in the request information match, transmitting request reply information that contains the positional information acquired by the position acquiring means to the different mobile station by the mobile communication;
request reply receiving means for receiving the request reply information from the different mobile station by the mobile communication; and
request reply position indicating means for indicating the positional information received by the request reply receiving means.

16. The communication system according to claim 13, wherein, when the acquired strength of the reception signal is a specific value, the signal-strength indicating means issues a warning.

17. The communication system according to claim 14, wherein, when the acquired strength of the reception signal is a specific value, the signal-strength indicating means issues a warning.

18. The communication system according to claim 15, wherein, when the acquired strength of the reception signal is a specific value, the signal-strength indicating means issues a warning.

19. The communication system according to claim 16, wherein the mobile station has freely changeable reception sensitivity for the short-range wireless communication.

20. The communication system according to claim 17, wherein the mobile station has freely changeable reception sensitivity for the short-range wireless communication.
